(19) United States
(12) Patent Application Publication
(10) Pub. No.: US 2014/0182561 A1
(43) Pub. Date: Jul. 3, 2014

(54) Onboard CNG/CFG Vehicle Refueling and Storage Systems and Methods

(71) Applicant: Eghosa Gregory Ibizugbe, JR., Lagos (NG)

(72) Inventor: Eghosa Gregory Ibizugbe, JR., Lagos (NG)

(21) Appl. No.: 14/137,727

(22) Filed: Dec. 20, 2013

Related U.S. Application Data
(60) Provisional application No. 61/888,481, filed on Oct. 8, 2013.

(30) Foreign Application Priority Data
Sep. 25, 2013 (NG) NG/P/2013/566

(51) Int. Cl. F02B 43/12; F02M 21/06; F02M 31/20; F02M 21/02

(52) U.S. Cl. CPC F02B 43/12; F02M 21/0215; F02M 21/0221; F02M 21/06; F02M 21/023; F02M 31/20
USPC 123/511; 123/527; 123/198 D; 123/540; 701/103

(57) ABSTRACT

Embodiments described herein provide a mobile refueling solution to vehicles that run on natural gas (CNG) or other gaseous fuels (CFG) through an integrated system of onboard compression, storage, interface modules and a central control architecture.

### RELATED APPLICATIONS

This application claims priority from Provisional Application No. 61/888,481, “ONBOARD CNG/CFG VEHICLE REFUELING AND STORAGE SYSTEMS AND METHODS”, filed 8 Oct. 2013, the disclosure of which is hereby incorporated herein by reference.

This application claims priority from Nigerian Application No. NG/P/2013/566, “ONBOARD CNG/CFG VEHICLE REFUELING AND STORAGE SYSTEMS AND METHODS”, filed 25 Sep. 2013, the disclosure of which is hereby incorporated herein by reference.

### TECHNICAL FIELD

Embodiments of the invention are directed in general to vehicle fuel systems and methods, and more specifically vehicles using compressed natural gas for fuel.

### BACKGROUND

Natural gas is commonly used as an energy source for heating, cooking, and electrical generation. It is also used as a fuel for vehicles. Natural gas is more plentiful and cheaper than gasoline. However, in North America, there are currently very few natural gas refueling stations for vehicles. Natural gas vehicles (NGVs) have been around for long and operate by utilizing compressed natural gas also known as CNG. Use of fuel gas other natural gas is called compressed fuel gas or CFG. Advantages of using CNG include: lower fueling costs—natural gas is cheaper than gasoline or diesel; environment benefits—combustion of natural gas emits far lower greenhouse gas emissions than gasoline or diesel. As a matter of fact, natural gas is the cleanest burning fossil fuel and unlike gasoline or diesel, combustion does not produce particulate emissions that cause air pollution. Advantages also include: safety—natural gas is a much safer fuel than gasoline or diesel as it has a narrower flammability range than both liquid fuels. It is also lighter than air, therefore in case of a leak, it quickly disperses into air with adequate ventilation.

Unfortunately a major problem that hinders wider scale adoption of natural gas powered vehicles exists, namely there is a huge deficit or shortage in the number of CNG supply stations worldwide compared those for liquid fuels, gasoline and diesel. In the United States alone, it estimated that there are roughly over 1000 CNG stations compared to over 120,000 stations for gasoline and diesel. Building up CNG fuel station and delivery infrastructure to be on par with current gasoline/diesel capacity is quite capital intensive and such investments takes time. This means current shortfall in number of CNG fuel stations will not be remedied for years to come.

### SUMMARY

This invention provides a solution to this CNG station unavailability problem by imparting a mobile refueling capability to vehicles that run on natural gas or other gaseous fuels. It does this through an integrated system of onboard compression, storage and interface modules and a centralized electronic control system. With this invention, fuel gas powered vehicles are effectively able to refuel from readily available sources of natural gas such as existing utility gas piping in residences and other building facilities with existing utility gas piping infrastructure. Current systems for vehicle refueling use a compression system that is external and separate from the vehicle.

One embodiment of the invention is directed to a compressed gas fuel system for a vehicle, wherein an engine of the burns high pressure gas fuel. The system comprises a compressor, which is mounted on the vehicle, for compressing low pressure gas fuel into the high pressure gas fuel; at least one storage tank, which is mounted on the vehicle, for storing the high pressure gas fuel; and an electronic control module, which is mounted on the vehicle, that controls the compressor and controls delivery of high pressure gas fuel from the at least one storage tank to the engine.

Another embodiment of the invention is directed to a method of using a compressed gas fuel system for a vehicle. The method comprises receiving low pressure gas fuel from a source external to the vehicle; compressing the low pressure gas fuel into high pressure gas fuel, wherein the compressing is performed onboard the vehicle; storing the high pressure gas fuel in at least one storage tank; delivering the high pressure gas fuel from the at least one storage tank to an engine of the vehicle; and controlling the compressing, storing, and delivering by an electronic control module located onboard the vehicle.

### BRIEF DESCRIPTION OF THE DRAWINGS

Having thus described the invention in general terms, reference will now be made to the accompanying drawings, which are not necessarily drawn to scale, and wherein:

FIG. 1 is a schematic illustration of an example of an embodiment of the major components of a CNG or CFG system, which allows for compressed fuel gas vehicle refueling and storage, and includes at least one storage tank, according to embodiments of the invention;

FIGS. 2A and 2B depict an example of an arrangement of the system of FIG. 1 in a vehicle;

FIGS. 3A, 3,B, and 3C depict different embodiments of the gas cooler of FIG. 1;

FIGS. 4A, 4B, and 4C are charts depicting examples of operation parameters of the system of FIG. 1;

FIGS. 5A, 5B-1, and 5B-2 depict an example of a schematic illustration of the centralized control architecture including the electronic control module (ECM) and architecture, according to embodiments of the invention;

FIG. 6 is a block diagram flowchart illustrating an example of an onboard refueling operation, according to embodiments of the invention;

FIGS. 7A and 7B depicts another example of the centralized control architecture including ECM and UIM and their respective internal components, and the inventories of sensory devices and control devices, respectively, according to embodiments of the invention;

FIGS. 8A and 8B are block diagram flowcharts illustrating examples of an operations for starting and stopping regeneration, according to embodiments of the invention;

FIGS. 9A to 9E are a series of illustrations depicting examples of different arrangements for the system of FIG. 1 in different types of vehicles; and

FIG. 10 depicts a block diagram of a computer system which is adapted to use the present invention.

### DETAILED DESCRIPTION

The invention now will be described more fully hereinafter with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. One skilled in the art may be able to use the various embodiments of the invention.

As the present invention relates to onboard refueling and storage of gaseous fuels, some of the words used in text and drawings like ‘CNG’, ‘ANG’, ‘Natural Gas’ relate to specific or subset embodiments as may be described and do not imply any restrictions or limitations as to scope and applicability of the invention on the composition or categories of gaseous fuels.

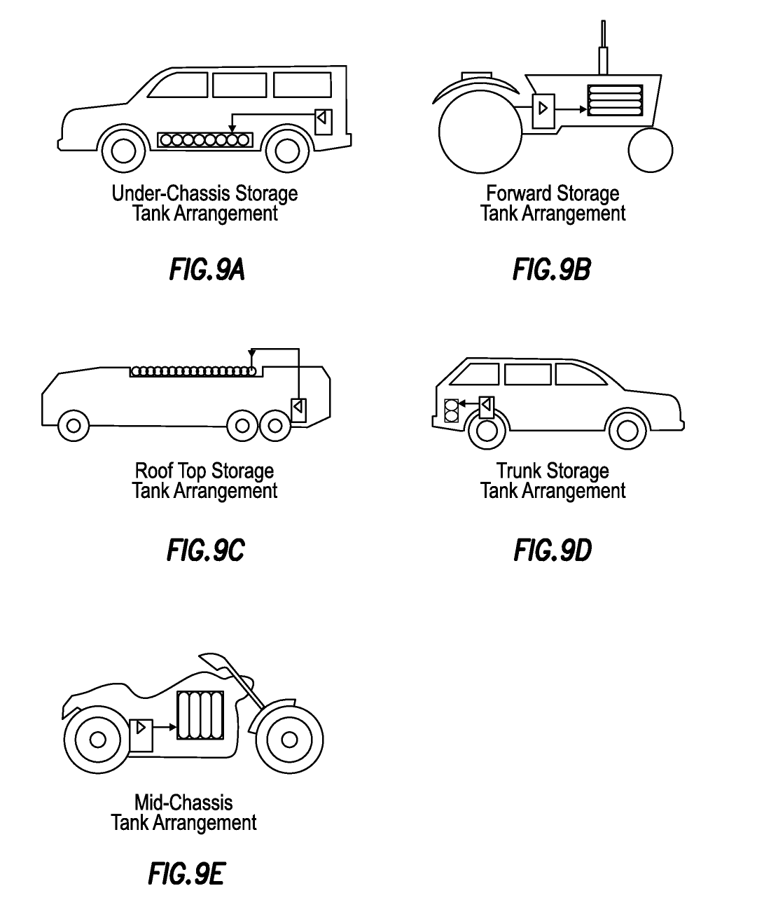

The present invention, in accordance with various embodiments is described in detail with reference to the following figured drawings which in no way limits nor restricts coverage of this invention over any modifications, excerpts or alternative forms or representations of this invention; neither is the placement of referenced components rigidly confined. Vehicle outline, storage tank location arrangements (FIGS. 9A to 9E) and system drawings in particular are provided for illustration and depict exemplary embodiments or instances. In addition, flowchart and algorithm drawings in particular denote a de-minimis or basic representation of the intended process or method described and therefore should not be construed as being inherently limited to those basic steps alone. These drawings are provided to facilitate reader's understanding of the invention and shall not be considered limiting of the breadth, scope or applicability of this invention.

Embodiments of the invention involve using compressed natural gas fuel for vehicles or Natural Gas powered Vehicles or NGVs. In many countries, a natural gas distribution system already exists. For example, in North America, very few compressed natural gas service stations exist. The main fuel is gasoline and diesel for vehicles. However, a home/business distribution system exists, wherein most home and commercial buildings in North America have natural gas distribution to the building.

Embodiments of the invention utilize a mobile compressed natural gas system and method for providing natural gas as fuel for vehicles. The embodiments allow for a vehicle to re-fuels at any natural gas distribution location, such as a the utility gas piping of a residential or commercial building. Any location that has utility gas can become a refueling point for a vehicle using embodiments of the invention. Thus, using the embodiments, a separate refueling service station is not needed. Note that the system can use gas that is at pressures in between utility and service station pressures.

Embodiments described herein provide a mobile refueling solution to vehicles that run on natural gas (CNG) or other gaseous fuels (CFG) through an integrated system of onboard compression, storage, interface modules and a central control architecture. Onboard refueling operation is accomplished by the compression module which is enclosed in a lightweight acoustic containment within the vehicle. Fuel gas from low pressure sources such as residential/commercial utility gas piping is hooked up to the vehicle fuel receptacle which feeds the compression module. Fuel gas is subsequently compressed to higher pressures and inter-cooling is implemented through a gas cooler to increase stored gas volumes prior to tank delivery. An electronic control module (ECM) utilizing stored algorithms administers control over onboard refueling, shutdown, regeneration (adsorbed tanks) operations as well as providing a means for temperature based repletion of storage tanks. The ECM allows for centralized control of the system. Human machine interface is provided by the user interface module (UIM) which domiciles system indicators and control settings. UIM also serves as a two way communication platform linked to the ECM and provides resources for transmission of audio visual alerts, wireless remote operation and network support. Refueling operation is initiated on the UIM via touch or voice activation. Physical definition of the UIM is very flexible, it could be a touch screen device, or an abstract projection or a panel with hard indicators and controls. The UIM may include abstract or physical representations of one or more of a touch screen, a control panel, dials, sensor readouts, and other controls that allows for a user to interact with the system.

The embodiments described herein may be built into a vehicle by the vehicle manufacturer or may be retrofitted into an existing car.

Embodiments described herein use a design model or philosophy that encompasses safety, tunability, optimization, reliability and maintainability or S.T.O.R.M. Safety means that the system will operate safety during a refueling operation, an engine on operation, an engine off operation, and an emergency off operation. Tunabililty allow for the system to change various settings as needed for different operations. Optimization allows for the system to run at peak efficiency during the different operations, as well as maximize the volumes of gas stored. For example, the system allows for a change in the maximum storage pressure based on ambient temperature. Reliability allows for the system to function dependably. In other words, the system will work as intended when required. Maintainability allows for the system to be kept in proper working order, as well as having features that enhance the ease of conducting maintenance services on the system. For example, the system can identify event drivers or components that triggered a shutdown as well as provide indication on a faulty component needs to be cleaned or replaced.

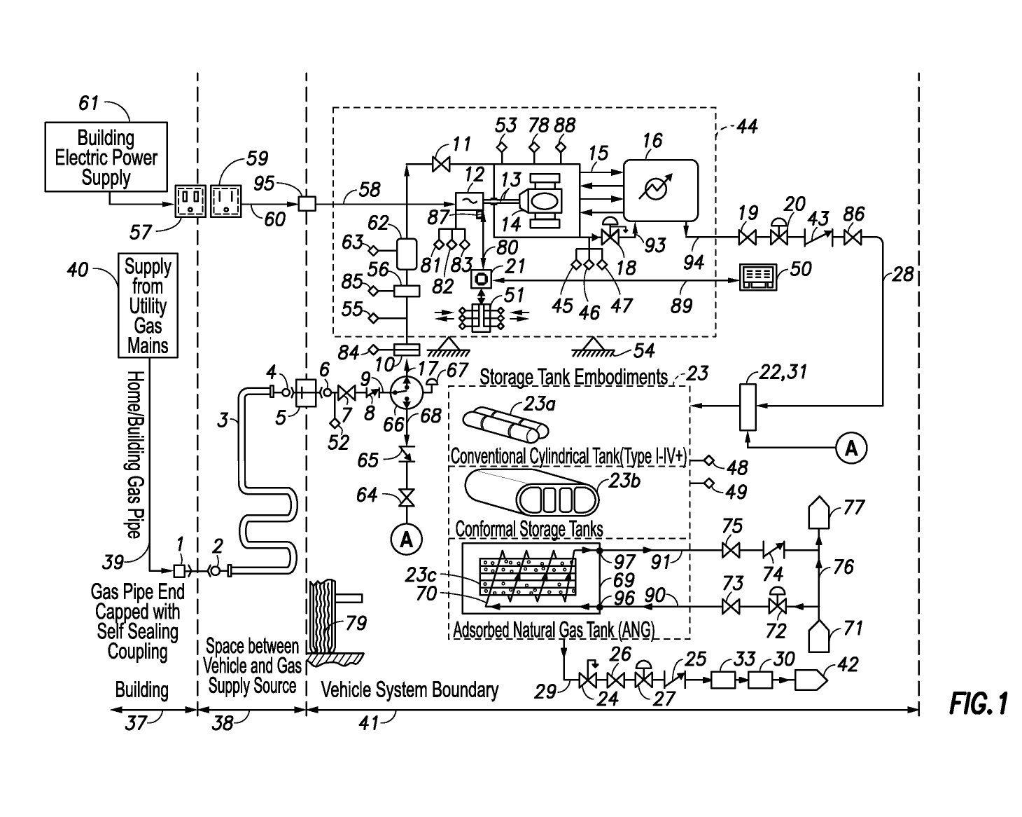

FIG. 1 is a schematic illustration of an example of an embodiment of the major components of a CNG or CFG system, which allows for compressed fuel gas vehicle refueling and storage, which uses at least one storage tank, according to embodiments of the invention. Note that the various positions of the valve and sensors is by way of example only, other embodiments can have the valve and/or sensors located in different positions along the operational pathways.

FIG. 1 has three main sections. One section is the building 37 section, which is separate from the vehicle 41 section. FIG. 1 also has the interface section 38 or the space between the building and the vehicle that allows for connections to be made between the building 37 and the vehicle 41. Tire 79 of the vehicle is shown for reference. The building 37 may be a home, an office, a store, an apartment building, a garage, a port facility, a natural gas tank, a bleed point in a gas pipeline, or any other facility or building that receives utility gas supply. The vehicle 41 may be a car, a truck, a pickup truck, a sport utility vehicle, a bus, a motor cycle, a tractor, construction equipment (e.g. a bulldozer or power shovel), other transportation vehicles such as trams, boats, or light aircraft, or any other vehicle that uses fuel gas to propel itself.

The CNG/CFG system has two main inputs. One input is electric power that the system receives via electric power intake receptacle 95, which is received from a building supply 61 of building 37. The electrical power intake receptacle 95 is connected to the outlet 57 of the building power supply 61 via power cable 60 that includes an electric plug 59. The power supply may be regular 110 or 220 VAC. Note that the system may be changed to use the voltage that is standard in the region of use. The electrical power is used to power the compressor motor 12, and the other electrical component such as the electronic control module (ECM) 21, the various sensor and valves, and user interface module or control panel (UIM) 50 during the refueling operation. The electrical power from the building is not needed for vehicle operation, the vehicle power is used to provide electricity to the ECM, sensors and valves, and UIM during vehicle operations. Note that as shown in FIG. 1, the electrical power feed line 58 runs directly into the compressor motor 12, in another embodiment, electrical power feed line 58 may run to the vehicle electrical power system, and the compressor motor is connected to the vehicle electrical power system. As a further embodiment, if the vehicle 41 has a large enough battery supply, then the vehicle battery may be used to power the compressor motor 12 during the refueling system.

The other input is natural gas, which is provide from a utility gas supply for gas mains 40, through the building gas pipe 39. Note that other gas fuels or admixtures may be used instead of natural gas, for example, hydrogen, dimethyl ether (DME), syngas, ethane, propane etc. The gas supply may be at standard utility pressure, e.g. 1.5 psi. The gas pipe 39 would be fitted with a capped end that has a self sealing coupling 1. The end cap 1 is connected to the vehicle 41 via a gas hose 3, which is a high strength flexible hose, and features a bayonet type dispenser end at the end sealing with the fuel receptacle 5. One or both end couplings 2, 4 may be self sealing, quick connect, breakaway couplings. The self sealing aspect is a safety feature that prevents the escape of gas if the hose 3 should be displaced during the refueling process. The hose 3 connects to the vehicle via the vehicle fuel receptacle 5.

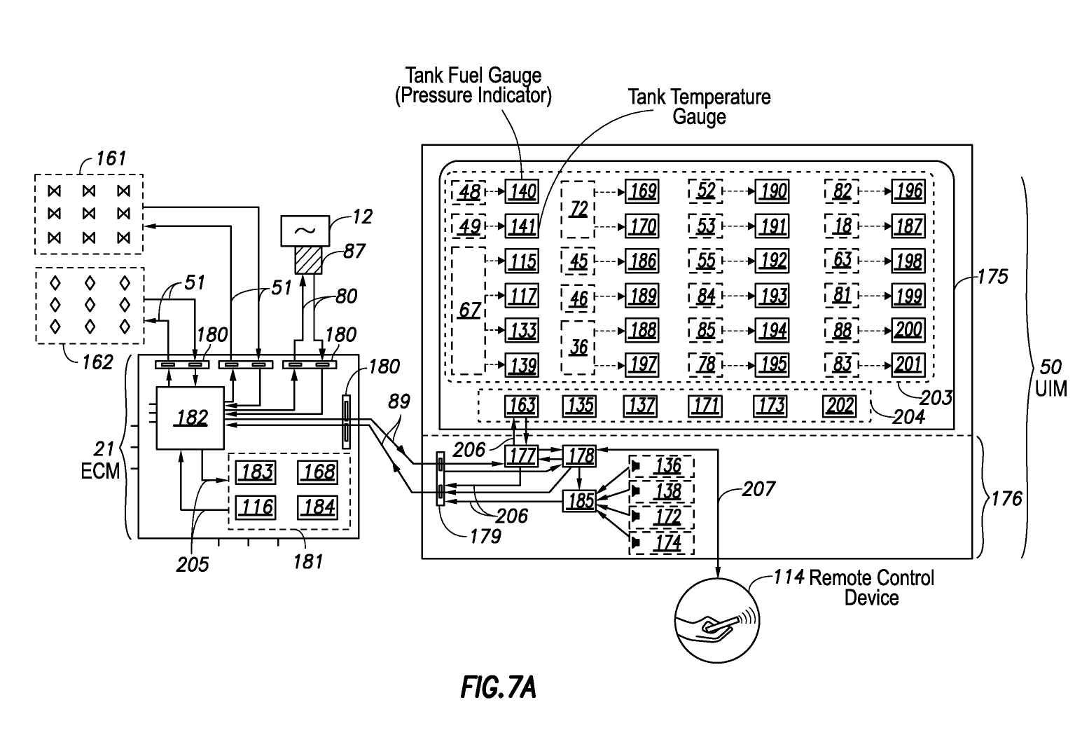

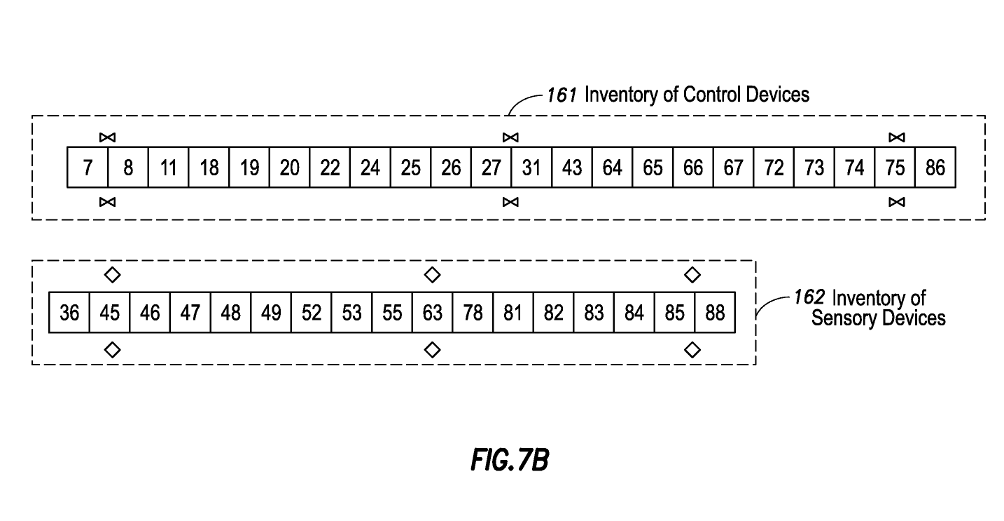

Fuel gas delivery line 9 delivers fuel gas from the receptacle 5 to the three port diverter valve 66. One component of fuel gas delivery line 9, located just inside the vehicle, is another self-sealing quick connect fitting 6. This provides a safety seal to prevent gas escaping from the vehicle, if the hose 3 is displaced during the refueling process. Adjacent to the fitting 6, is a safety shut-off valve 7. Note that valve 7 is one of the control devices used by the system. This valve and the other valve/components are connected to the ECM 21 through the bus 51. The state of this valve and the other valves/components may be displayed to the user by UIM 50, which is connected to the ECM 21 by power/data line 89. FIG. 7B depicts an inventory of control devices 161. Also note that the valve 7 is automated and is controlled by the ECM 21. The valve 7 is in communication with the ECM 21, the valve sends its status, e.g. open, closed, opening, or closing, to the ECM 21, and the ECM issues commands to the valve, e.g. open, close, maintain current position.

Just prior to the valve 7 is sensor 52, or flammable gas detector A, which a flammable gas lower explosive limit (LEL) detector. Since the receptacle 5 is going to be repeatedly used during the life of the vehicle, there is a possibly of wear and/or fatigue that may occur at the receptacle connection point. This sensor will detect a potential gas leak resulting from connection wear or piping failure. If there is a leak and the gas concentration reaches a threshold limit, then the ECM will initiate a shutdown of the refueling process. Note that sensor 52 is one of the control devices used by the system. FIG. 7B depicts an inventory of sensor devices 162. This sensor and the other sensors are connected to the ECM 21 through the sensor bus 51. The value of this sensor and the other sensors/components may be displayed to the user by UIM 50. The last component of gas line 9 is the check valve 8. This prevents any back flow of natural gas to the receptacle 5.

Fuel gas delivery line 9 connects to the three port diverter valve 66. This valve switches between two flow paths. Gas from receptacle 5 may flow on either path 17 or path 68. Path 17 is flow path to the compression module. Path 17 is used for utility pressure gas source, where compression is needed. Path 68 is a bypass path, the bypasses the compressor and allows for direct refueling of the fuel tanks. Path 68 would be used when the fuel source is already at a high pressure and does not need to be further compressed, for example a CNG gas station. Note that the pressure sensor 63, pressure sensor A, can determine if the inlet pressure is too high to use the compressor and switch the system to direct refueling along path 68. The valve 66 is driven by actuator 67, which is controlled by the ECM.

On flow path 68, the line comprises check valve 65, which prevents back flow of gas into the diverter valve 66. Path 68 also includes safety valve 64, which provides isolation between the diverter value 66 and the manifold 22. When the compressor is being used, valve 64 prevents any flow along path 68. As indicated by (A), path 68 continues into the tank manifold 22, which comprises one or more valves 31. The valves 31 allow multiple tanks to be filled one (or more) at a time, or all at once. For embodiments with a single tank, there would be only one valve. For embodiments with two or more tanks, there may be one or more valves. The manifold 22 is the merge point of paths 17 and 68.

Returning to path 17, the path 17 includes intake filter 10. The filter is part of the reliability aspect. The filter 10 prevents solid particles from entering into the system, and make the system more reliable. The differential pressure sensor 84 monitors the intake filter 10. This sensor is part of the maintainability aspect. Data from the this sensor allows the ECM to tell the user to change or clean the filter 10. As the filter becomes dirty, the pressure difference between the two sides of the filter increases. If the pressure differential is high enough, the ECM may trigger a system shutdown, and halt refueling.

Path 17 crosses into enclosure 44, which is a light weight acoustic enclosure. The enclosure 44 is part of the safety aspect. Enclosure 44, also known as compression module, reduces the sound and vibrations from the compressor 15, and provides physical protection in case of compressor failure. The enclosure may be made from light weight, high strength materials such as aluminum, Kevlar, carbon fiber, and may be lined with sound proofing material such as acoustic foam, anechoic rubber tiles, etc. The attachment points or mounts 54 for mounting the enclosure 44 onto the vehicle are vibration dampeners or bushings. The mounts reduce vibrations from the compressor that are transmitted to the vehicle. This incorporation of dampeners 54 which reduces the overall vibration level of the compression module, preserving compressor service life. This is consistent with the reliability aspect and benefits intended under the S.T.O.R.M design model.

The enclosure 44 comprises sensor 55, which is an oxygen sensor. This sensor is part of the safety aspect, and detects the level of oxygen that is present in the natural gas. If the amount is too high, then the gas itself becomes explosive, and compression of the gas may cause detonation from the heat that is caused by compression. If the amount of oxygen is too high, then the ECM may initiate shut down.

The path 17 continues to removeable moisture extractor 56, which removes excess moisture from the natural gas. The extractor 56 may be a molecular sieve, or a moisture extraction media, e.g. charcoal. The extractor contributes to the reliability aspect of S.T.O.R.M. Excess moisture can cause rust or oxidation and failure to occur within the various pieces of the system, e.g. the compressor, the valves, the sensors, the tank(s). Sensor 85 is connected with extractor 56, and is a differential pressure sensor that monitors the extractor 56. This sensor is part of the maintainability aspect of S.T.O.R.M. Data from the this sensor allows the ECM 21 to alert the user, via the UIM 50, to change or clean the moisture extractor 56. As the moisture extractor becomes saturated with water, the pressure difference between the two sides of the extractor increases. If the pressure differential crosses a predetermined set point threshold stored in the ECM internal memory 181, the ECM may trigger a system shutdown, and halt refueling.

The path 17 continues to gas accumulator 62, which is a small vessel, that provides an accumulation of volume of gas. This smoothes out the operation of compressor 14. The compressor intake pressure is not constant, but varies as the compressor draws in a quantity of gas, and then pauses, before drawing in the next quantity. The accumulator provides a buffer of gas that reduces the pressure or vacuum changes that are expressed on the upstream components, e.g. extractor 56. Accumulator 62 includes pressure sensor 63, which detects pressure values within the accumulator 62 and relays the values to the ECM 21. The accumulator is part of the reliability aspect and the optimization aspect. The sensor 63 is part of the optimization aspect of S.T.O.R.M.

The path 17 continues with valve 11, which is the inlet suction valve for the onboard compressor 14. The compressor 14 may be a positive displacement compressor with a reciprocation action. The compressor may have multiple stages, with each successive stage increasing the pressure of the gas with respect to the prior stage. The compressor may be a radial type or a screw type. The compressor may have 4 stages. Note that other types of compressors may be used. The compressor receives gas at about 1.5 psi (or whatever the standard pressure for utility gas service) and compresses the gas up to CNG standard discharge pressure, which is either 3000 psi or 3600 psi. Note that other pressures may be used, particularly if adsorbed natural gas (ANG) tanks are used. ANG tanks use a lower storage pressure, e.g. 500 psi. The material, known as adsorbents such as activated charcoal, zeolites, etc., in the ANG tanks has a large surface area, wherein the natural gas molecules adhere to the surface. The result is the same amount (volume) of gas may be stored at a lower pressure in an ANG tank, as is stored at a higher pressure in a regular tank. The lower pressure allow for a safer and more reliable system, in that less pressure is applied to components and fittings, which means the system is less likely to leak and is more safe. This allows for less consumption power during the compression of the gas.

The compressor 14 is driven by compressor motor 12, which uses electricity from the building power supply 61 through electric power feed connection 58. The motor 12 is connected to the compressor 14 via drive shaft 13. The motor 12 includes a electric motor controller 87, which is connected to the ECM 21 via control line 80. The motor controller allows for the ECM to control the motor by turning the motor on/off and increasing/decreasing the RPM of the motor. The controller 87 is part of the optimization aspect. Note that other connecting lines for signals and/or power for other sensors, controllers, and valves are not shown for simplicity. The compressor 12 includes three sensors, namely 81, 82, and 83. Sensor 81 is a motor RPM sensor, which monitors the speed of the motor. This sensor is part of the optimization aspect. Sensor 82 is motor temperature sensor, which detects the temperature of the motor. If the temperature is too high, the ECM may trigger a shut down, or slow down of the motor until the temperature returns to an acceptable amount. This sensor is part of the safety aspect. Sensor 83 is a motor voltage and amperage meter, which detects the amount of energy being used by the motor. This sensor contributes to the tunability aspect of S.T.O.R.M. The data from these sensors are provided to ECM 21. The information may be displayed on UIM 50.

The compressor 14 includes three sensors, namely 53, 78, and 88. Sensor 53, flammable gas detector B, is a flammable gas lower explosive limit (LEL) detector. Sensor 53 checks for gas leaks within enclosure 44. If there is a leak and the gas concentration reaches a threshold limit, then the ECM will initiate a shutdown of the refueling process. This sensor contributes to the safety aspect of S.T.O.R.M. Sensor 78 is an accelerometer. This sensor measures movement of the vehicle during onboard refueling operation. Any powered or unpowered movement from parked position or towing of the vehicle while parked is immediately detected by the accelerometer and feedback relayed to the ECM. If the movement exceeds a predetermined amount, then the ECM will trigger a shut down. For example, if the vehicle is hit or towed while being refueled, then the refueling is halted. This sensor contributes to the safety aspect of S.T.O.R.M. Sensor 88 is a chronometer, which logs the compressor run time. This sensor contributes to the maintainability aspect of S.T.O.R.M. This ensures event logs of compressor runtime and other operational data are recorded in the ECM internal memory 181 and such information is available for vendor use during servicing or repairs. The information stored in the ECM internal memory 181 also allows the user to be informed that service is needed.

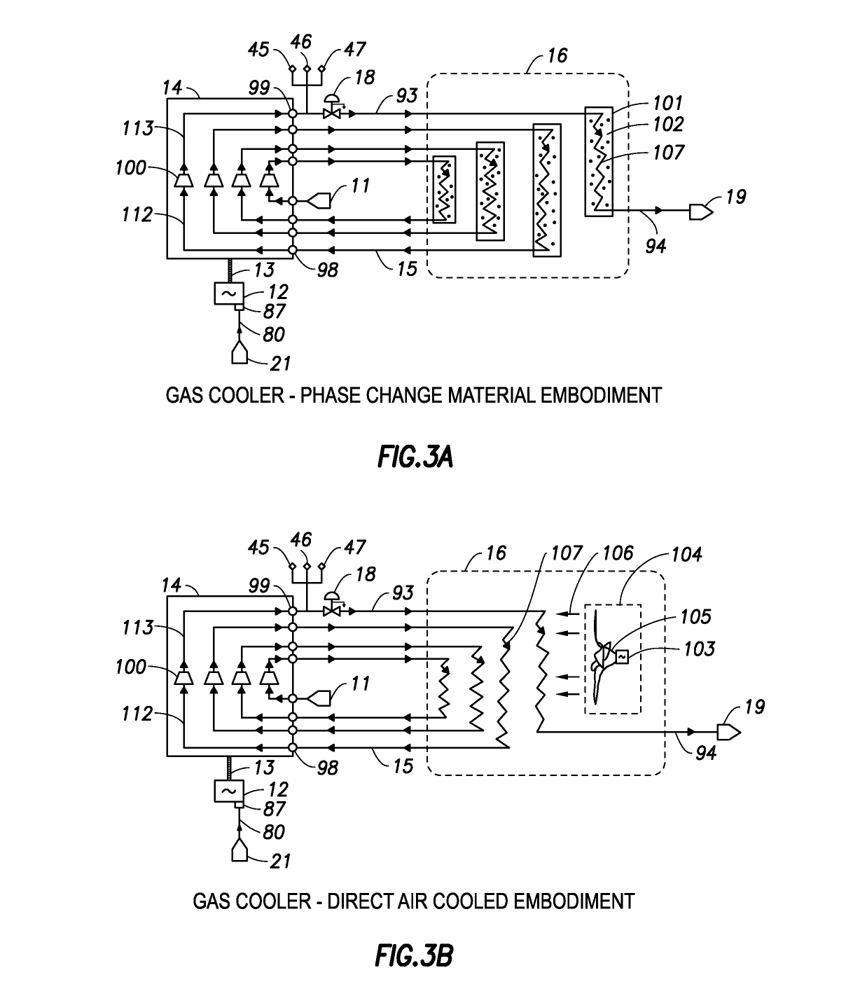

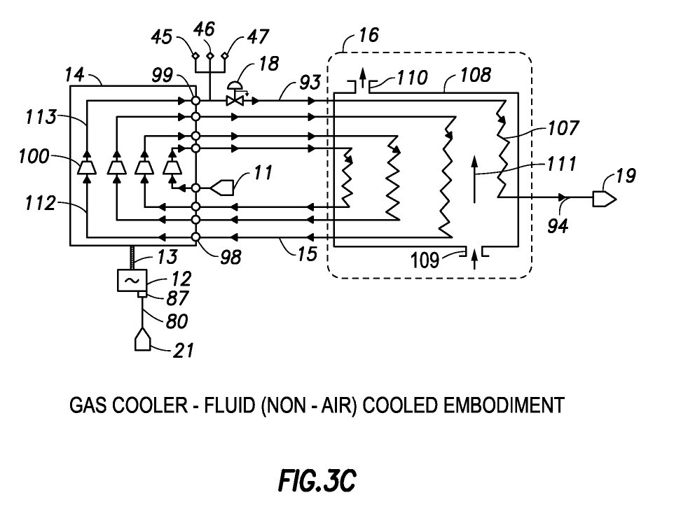

The compressor 14 interacts with the gas cooler 16 via piping 15 through inlet ports 98 and discharge ports 99 of the compressor 14, as shown in FIGS. 3A-3C. Inter-stage piping within the compressor includes the upstream 112 piping and downstream piping 113 to move the gas through the stages 100 between the ports 98 and 99. The gas cooler cools the gas after each stage of compression. Without the gas cooler, the gas is heated by compression and much hotter than ambient temperature when placed into the tank. As the gas in the tank cools, the compression drops, so the that tank is not filled to full capacity. Thus, during the filling operation, the pressure may indicate that the tank if full, but as the gas cools to ambient temperature, the pressure drops leaving the tank unfilled. With the gas cooler 16, the gas temperature is lowered to (or nearer to) ambient temperature after each stage of compression. This improves the efficiency of each stage, and allows the tank to be filled (closer to) actual capacity. Thus, the gas cooler allow for more gas volume to be stored at fill time, which translates to more range for the vehicle. The gas cooler 16 contributes to the optimization aspect of S.T.O.R.M.

FIGS. 3A to 3C depict different embodiments for gas cooling with a multiple stage compressor. FIG. 3A depicts the use of a phase change material (PCM) 102. PCM are materials have a high latent heat values. The material absorbs the heat by changing phase, e.g. solid to liquid, and liquid to gas, with solid to liquid phase change materials being preferred. The material cools and returns to the original or base state, e.g. solid. The PCM material 102 is located within PCM liner 101. The discharge lines 15 from the various compressor stages 100 contact the PCM material 102 in the heat exchanger contact area 107. After the cooling, the gas is returned to the compressor for further compression by return lines 15. After cooling the gas from the final stage via final discharge line 93, the gas exits the cooling material via final discharge line 94. This embodiment has no moving parts and consumers a small amount of space. This embodiment is well suited for space constrained applications such as smaller vehicles that have smaller tanks, for example a motorcycle.

FIG. 3B depicts the use for air as the coolant. The arrangement of FIG. 3B is similar to that of FIG. 3A, but uses a cooling fan 105 with fan motor 103 and fan guard 104 to provide air flow 106 as the coolant. FIG. 3C depicts the use of fluid, which may be a liquid or gas (other than air) as the coolant. The arrangement of FIG. 3C is similar to that of FIG. 3A, but uses a heat exchanger shell with cold fluid inlet 108 and fluid exit 109 to allow for cold fluid flow 11 to pass across the contact area 107. This fluid may be radiator fluid that is tapped from the engine cooling system of the vehicle.

Returning to FIG. 1, the final discharge line 93 leaves the compressor 14 and has three sensors on the line, sensors 45, 46, and 47. Sensor 45 is the compressor discharge pressure sensor, which measures the gas pressure as it exits the final stage of the compressor. Sensor 46 is the compressor discharge temperature sensor, which measure the temperature of the compressed gas as it exits the final stage before entering the cooler 16. Sensor 47 is the compressor discharge flow meter, which measures the volume flow rate, e.g. cubic feet per second. This provides fill information to the ECM. This contributes to the optimization aspect of S.T.O.R.M. After the sensors, there is a valve 18, which is the compressor discharge pressure relief valve. This valve contributes to the safety aspect of S.T.O.R.M. The valve acts to release gas if there is an overpressure situation indicated by the sensors 45, and trigger a shut down. The valve, like the other valves of the system, is controlled by the ECM.

Final discharge line 94 from the cooler 16 provides the compressed, cooled gas to the tank. In this line is a valve 19, which is a safety shut-off value. Line 94 then proceeds to valve 20, which is a pressure regulator. This valve is variable, and can step down the pressure of the gas as needed. This valve is controlled by the ECM 21. Next on line 94 is valve 43, which is a check valve, which prevents the back flow of gas into the cooler 16. Line 94 then proceeds to valve 86, which is an isolation valve, which allows for the compressor to be worked on in isolation of the tanks. The valves 19, 20, 43, and 86 are connected to the ECM 21 via bus 51.

After valve 86, the high pressure fuel line 28 leads to the tank manifold 22, which comprises one or more tank manifold valves 31. The valve(s) 31 control the flow of gas into the storage tank(s) 23. FIG. 1 depicts three different tank types, normally only one tank type would be used. There may be one or more storage tank(s). Tank 23a is a conventional tank, typically a cylindrical tank. Tank 23b is a conformal storage tank. This tank has no standard profile, and instead follows the space constraints of space available for fuel storage. This tank can be used for smaller vehicles, such as a motorcycle.

Tank 23c is an adsorbed natural gas (ANG) tank. One common ANG material is activated charcoal. Note that the profile of the ANG tank may be a standard cylindrical tank 23a or a conformal tank 23b. Tank 23 is filled with an adsorbent material that allows for a lower compression of the gas, e.g. about 500 psi rather than 3600 psi. Tanks 23c is located inside enclosure 69.

Tank 23c uses the exhaust gas from the engine as the heat source to promote disassociation of the stored gas from the ANG material. Hot exhaust gas 71 from the engine is bled from the exhaust system by bleeder value 72, which is controlled by the ECM, which bleeds off a portion of the gas from header 76. The remainder of the gas travels through the header 76 and into the exhaust handling system of the vehicle via outlet 77. The bleeder 72 can control the amount being passed through the valve 72, as the vehicle exhaust system heats up, less exhaust is needed to be bled. The exhaust system includes two safety shutoff values, namely 73 and 75, which shut off the flow of exhaust gas, and thereby reduce or stop the disassociation of the stored gas from the ANG material. Check valve 74 prevents the back flow of exhaust. The exhaust flows into and out of the ANG regeneration heater loop 70 via bleed lines 90 and 91 through ports 96 and 97. Heater loop 70 may coil completely or partially around the tank, or is placed adjacent to the tank so that the heat from the exhaust migrates into the tank and reacts with the ANG material. Note that other heat sources could be used, for example an electrical resistance heater. Another heat form may be from the engine coolant system, however, this form would heat up slower than the exhaust gas embodiment. Note that exhaust gas heating uses a waste energy and thus is the most economical.

The tank 23 includes two sensors, namely sensor 48 and 49. Sensor 48 is the storage tank pressure sensor, which measures the gas pressure inside the tank. This measurement indicates gas quantity in the tank. The information from this sensor is relayed to the ECM 21 and stored in the ECM internal memory 181. Information from this sensor is also displayed on the UIM 50 via the pressure indicator 140. Sensor 49 is the storage tank temperature sensor. This sensor has at least two transducers (not shown), with at least one measuring the internal tank temperature, and at least one other measuring the ambient air temperature. Thus, the tank temperature sensor 49 relays at least two datasets of temperature readings to the ECM 21, internal tank temperature and external ambient air temperature. These temperature readings are stored in the onboard refueling program memory block 116 located within the ECM internal memory 181. Information from this sensor is also displayed on the UIM 50 via the tank temperature indicator or gauge 141. These sensors contributes to the optimization aspect of S.T.O.R.M. This temperature information is used to change the set point for a full tank during tank repletion. The lower (colder) the ambient temperature during filling, the lower the maximum pressure of the tank will be set.

This process of ambient temperature based repletion or filling of the fuel storage tank 23 is another optimization-focused feature. The system ensures that the maximum fill pressure of the storage tank is not a fixed value but is a variable parameter that is determined by taking into account the ambient temperature as at time of onboard refueling. This helps avert potential fuel tank overpressurization should meaningful rise in ambient temperatures later occur in the day.

For example a rainy cold morning transiting to a hot noonday. The method by which this level of optimization is achieved is as follows. The tank temperature sensor 49 continuously checks the ambient temperature 164 during onboard refueling process and relays data to the ECM 21. The ECM cross checks ambient temperature input data 164 to the corresponding range of maximum fill pressure values 165 pre-stored in its internal memory 181. A reduction in ambient temperature 164 will necessitate a lower threshold for maximum fill tank pressure 165. When tank pressure exceeds the determined maximum fill value 165, the ECM shutdowns the compressor motor 12, which in turn terminates compression operation, ending the onboard refueling process.

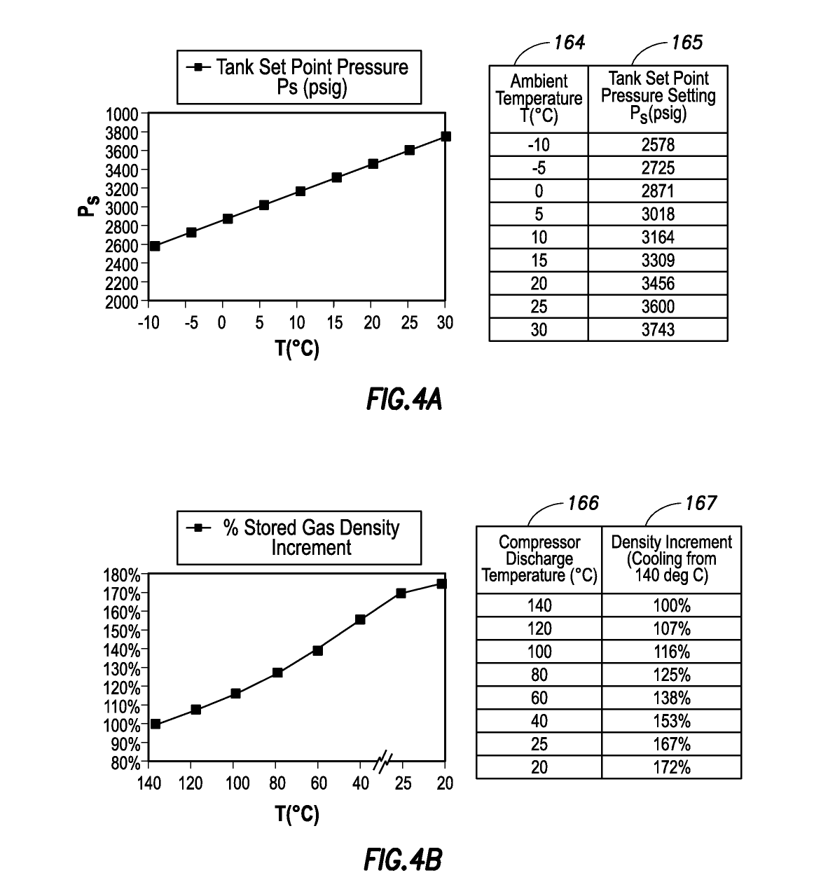

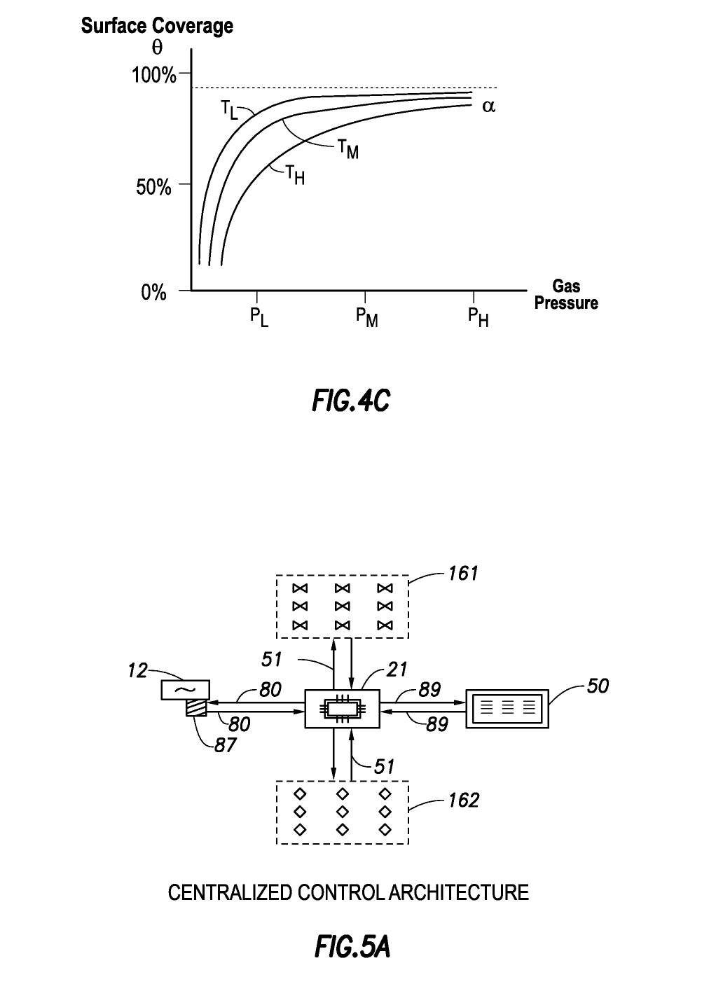

This example is shown in FIG. 4A, which shows that an ambient temperature 164 readout of 10 degrees C. allows for a set-point 165 of 3164 psi, while an ambient temperature of 30 degrees C. allows for 3743 psi set-point. This corresponding range of maximum fill pressure values 165 is also pre-stored in the ECM internal memory 181, within the memory block containing the onboard refueling program or algorithm 116 (similar to the temperature monitoring data 164).

The high pressure fuel line 29 leaves the tank(s) is delivers the fuel gas to the engine. Line 29 includes valve 24, which is a tank discharge pressure relief valve. This valve allows for tank to evacuate excess gas in an overpressure situation. Line 29 includes valve 26, which is a safety shut off valve. Line 29 includes a pressure regulator 27. This valve reduces pressure variation of the gas going to the engine. Line 29 includes check valve 25 which prevents backflow of gas into the tank 23. Line 29 includes fuel filter 33 which removes any solid particles from the gas. The particles may have been introduced by the tank 23, particularly if the tank in an ANG tank. Line 29 includes accumulator 30, backend accumulator or accumulator B, which is used to hold a quantity of starter gas fuel for use by the engine. The accumulator 30 is particularly useful at engine startup, and provides a reservoir of gas for startup. This arrangement is particularly needed for ANG tanks, which may not have any disassociated gas available until engine heat is provided. In non-ANG embodiments, this backend accumulator provides instant supply of gas the vehicle engine 42 can draw on when accelerating. This contributes to the optimization aspect of S.T.O.R.M. Line 29 ends at the vehicle engine system 42. The engine system receives the gas and provides it to the cylinders for engine operation.

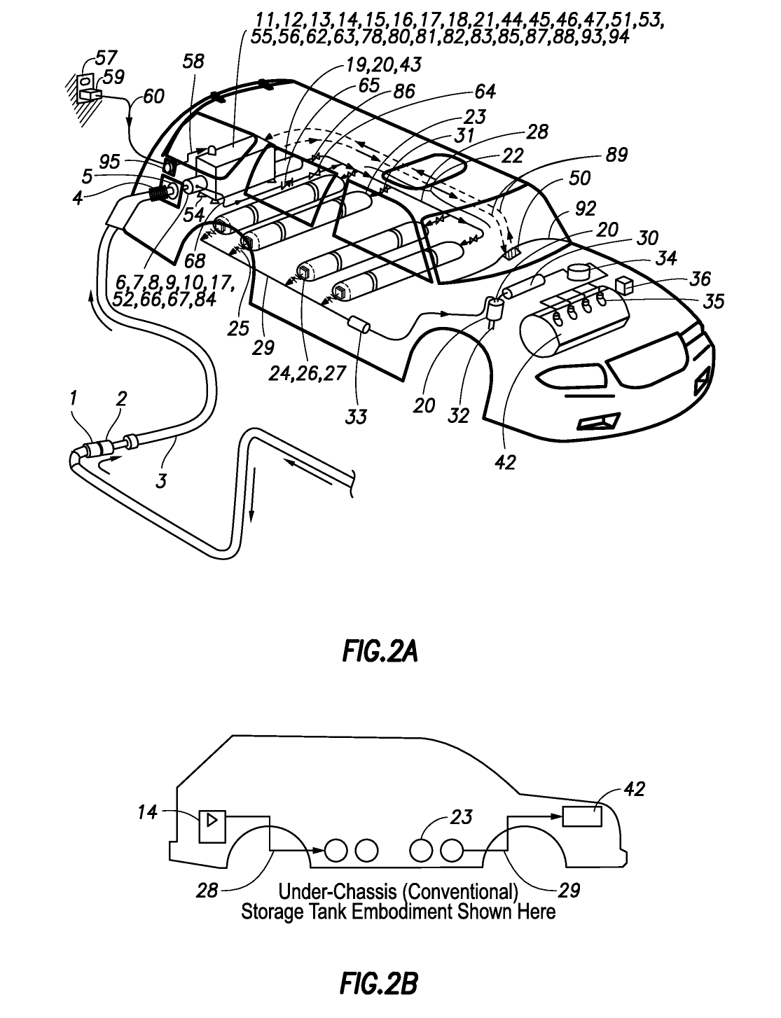

FIGS. 2A and 2B depict an example of an arrangement of the CNG or CFG system of FIG. 1 in a vehicle. In FIG. 2A, the vehicle is shown in outline form to illustrate an example of the fueling-storage system of FIG. 1 set up within the vehicle, as well as the external connection of the gas supply to the vehicle. Note that in FIG. 2A, the storage tanks are depicted to be conventional storage tanks, and are located under the vehicle chassis. This is by way of example only, as other tanks could be used, and the tanks by be located in a different location in the vehicle, e.g. in the trunk, on the roof, etc.

FIG. 2A depicts the various items of FIG. 1, and also includes various vehicle components such as pressure regulator 20, the vent tube 32, the metering-distribution control 34, the dashboard 92, the engine injectors 35, the vehicle control unit 36, and the communication loop 89 between the ECM 21 and the UIM 50. The vehicle control unit 36 provides various inputs to the ECM 21, including the status of the vehicle, e.g. that the engine is being started, that engine is currently running, that the engine is being turned off. These signals are used by the ECM 21 to make decisions about system operations. For example, if during refueling operations, the engine is started, the ECM 21 receive an alert from the vehicle engine control unit 36 and promptly would initiate system shutdown. This contributes to the safety aspect of S.T.O.R.M.

The at least one portion of the UIM 50 is located in the dashboard. This would allow the user to monitor and control the system during vehicle operations, e.g. driving. One implementation of the UIM is a touch screen. Another portion of the UIM (not shown) may be located adjacent to the fuel receptacle 5. This would allow the user to monitor and control the system during refueling operations. Another portion of the UIM may be resident on a portable electronic device 114, e.g. a smart phone. This would also allow the user to monitor and control the system during refueling operations. Another portion of the UIM (not shown) may be located at a distant building. For example, the central dispatch of bus company or trucking company. As another example, the monitory station of the manufacturer of the vehicle or system vendor. This would allow remote monitoring the vehicle operations. The UIM also includes support for wireless operations through a wireless link 207 and use of a dedicated remote control device 114.

FIG. 2B is a side elevation view of a schematic outline of the arrangement of FIG. 2A, and highlights fuel gas flow path from onboard compressor to storage tanks (conventional tank embodiment) and onward delivery to vehicle engine.

FIGS. 4A, 4B, and 4C are graphs and charts depicting examples of operation parameters of the system of FIG. 1. FIG. 4A is a graph and corresponding chart showing the preferred set-point range used by the system to adjust maximum tank fill pressure depending on ambient temperature. Note that this is for conventional tanks, other tank types would have different set-points. The lower or colder the ambient temperature during filling, the lower the maximum pressure of the tank. Thus, at an ambient temperature 164 of 10 degrees C., the set-point 165 is at 3164 psi, while an ambient temperature of 30 degrees C. the set-point is 3743 psi. The system allows for a temperature based repletion or refueling. This prevents tank rupture, if the ambient temperature increases after tank filling. This also provides for consistent refills (similar number of gas molecules) at different temperature. Thus, the vehicle will have the same driving range when filled at different temperature. The temperature and pressure readings are provided to the ECM 21 by sensors 48 and 49. The data of FIG. 4A, and similar charts is encoded into the ECM 21.

FIG. 4B is a graph and corresponding chart showing increments in stored gas density verses temperature drop, which highlights the benefits of inter-cooling as provided by the gas cooler 16 within the compression module 14 shown in FIGS. 3A-3C. Compression generates a large amount of heat. Storing heated gas raises the pressure, thus when cooling over time, the pressure reduces resulting in an unfilled tank. For example, cooling the gas to a discharge temperature 166 of 20 degrees C. resulting in an increase of 67% (to 167%) of density 167 over a gas that has a discharge temperature of 140 degrees C.

FIG. 4C is a chart depicting an elementary representation of the Langmuir Gas Adsorption model, which for all other factors remaining constant, relates adsorption of gas molecules onto an adsorbent as function that increases with rising gas pressure or decreases with rising gas temperature. This data is with respect to ANG tanks, e.g. tank 23c. The chart depicts the surface coverage or percentage adsorption increases with pressure for the various temperature isothermals α. Hence as pressure increases the surface of the adsorbent material becomes saturated, and when temperature increases, the adsorbent material in the tank releases gas which is known as desorption or regeneration.

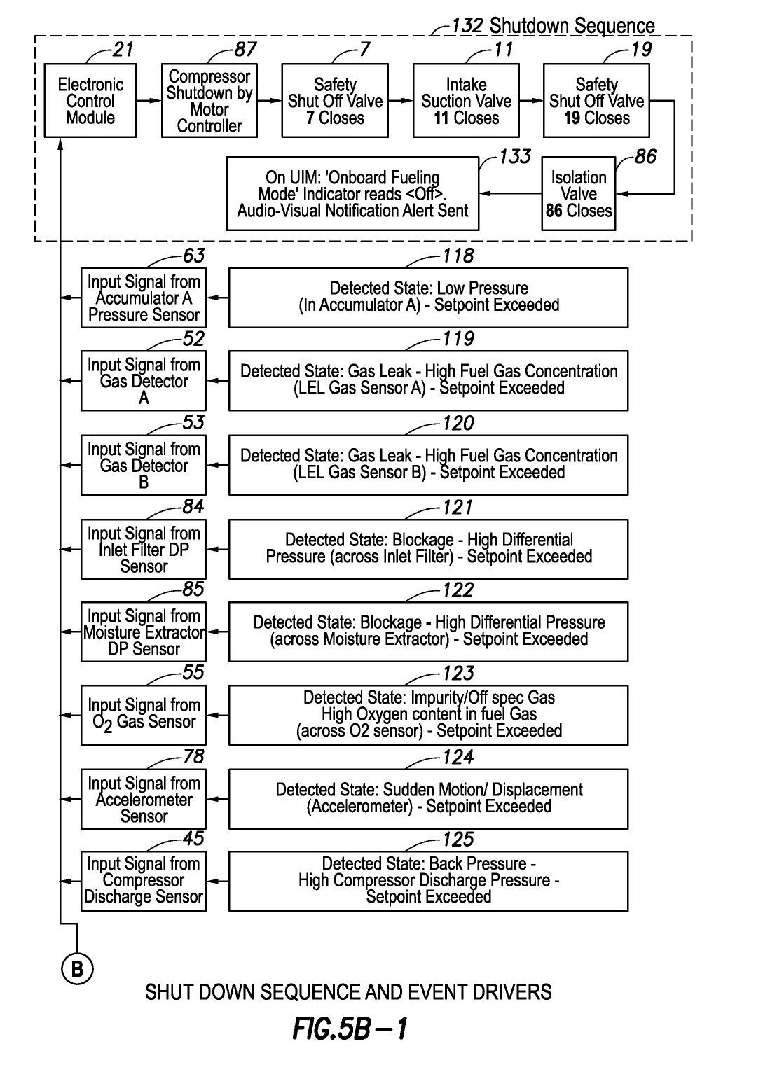

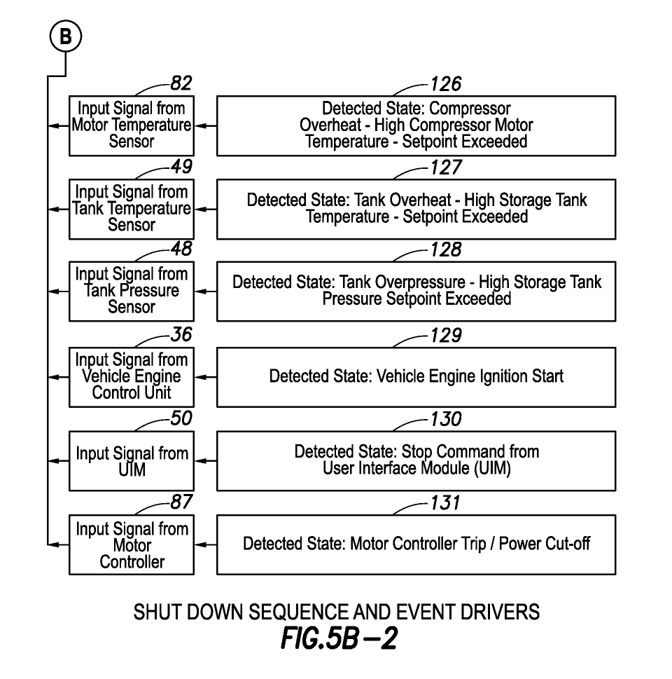

FIGS. 5A and 5B depict an example of a schematic illustration of the centralized control architecture including the electronic control module (ECM) and architecture, according to embodiments of the invention. FIG. 5A is a schematic illustration of the centralized control architecture which exhibits the ECM 21 as the decision-making core of the system with communication loops 51, 80, 89 linking the UIM 50, compressor motor 12, various sensory devices 162 and various control devices 161 to the ECM 21. FIG. 7B depicts the inventory of control devices 161 and the inventory of sensory devices 162. The communication loops may be single, bidirectional wire, or may be two wires. The communication loops may also include power.

FIG. 5B-1, and as continued in FIG. 5B-2, depicts a block diagram flowchart that illustrates an example of a shutdown operation to halt refueling. The electronic control module (ECM) 21 uses this chart to respond to and drive system shutdown operation for safety or operational purposes. The flowchart also shows the various initiating events that could prompt a shutdown.

The ECM 21 receives various signals from various sensory devices and control devices. When one of the signals exceeds a predetermined threshold, the ECM shuts down the system. The ECM 21 turns off the compressor motor 12 via the electric motor controller 87. The ECM 21 shuts off valve 7, closes off intake suction valve 11, shuts off valve 19, and shuts off valve 86. The ECM signals the shut down to the user via UIM 50 by signaling the user with onboard fueling mode indicator signaling off 133. Note that 87, 7, 11, 19, 86, may be shut off in a different order, or substantially simultaneously. By substantially simultaneously, it is understood that the instruction may be sent simultaneously, however, the different components may take different amounts of time to shut down.

The following is a list of the different states that would trigger a shut down. Note that this is not an exhaustive list, as other states may be used to trigger a shut down. One state is a low pressure state 118 in the accumulator 62 as detected by sensor 63. Another state is a gas leak state 119 near the receptacle 5 as detected by sensor 52. A further state is a gas leak state 120 in near the compressor 14 as detected by sensor 53. A further state is a filter blockage state 121 in the filter 10 as detected by sensor 84. A further state is a filter blockage state 122 in the moisture extractor 56 as detected by sensor 85. A further state is a gas impurity state 123 in line 17 as detected by sensor 55. A further state is a motion states 124 in line 93 as detected by sensor 78. A further state is back pressure state 125 in line 17 as detected by sensor 45. A further state is a compressor overheat state 126 of the compressor 14 as detected by sensor 82. A further state is a tank overheat state 127 of the tank 23 as detected by sensor 49. A further state is a tank overpressure state 128 of the tank 23 as detected by sensor 48. A further state is an engine startup state 129 of engine 42 as indicted by the engine control unit 36. A further state is a UIM stop command 130 delivered from the UIM 50. A further state is a power cutoff state 131 of the power to the compressor 14 as indicated by a signal sent from the motor controller 87.

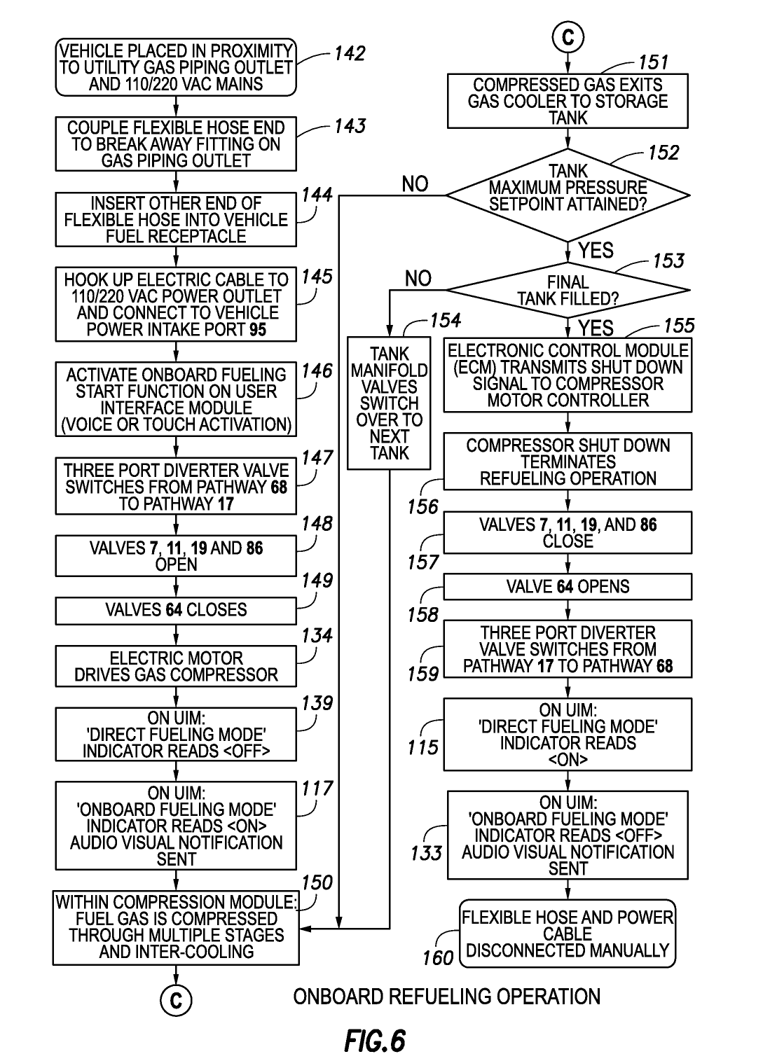

FIG. 6 is a block diagram flowchart illustrating an example of an onboard refueling operation, according to embodiments of the invention. In box 142, the vehicle is placed proximate to a utility gas service outlet 1 and electrical power supply 61. Next, the vehicle is connected to the gas supply by connecting a hose to the gas supply 143 and connected the vehicle to the hose 144. The vehicle is then connected to the electrical power 145. The refueling operation is initiated 146 by a command given to the ECM 21 via the UIM 50.

With refueling initiated, the three port diverted valve 66 switches 147 to pathway 17, if not already set to pathway 17. Valves 7, 11, 19, and 86 are opened 148, and valve 64 is closed 149. The electric motor 12 turns 134 the compressor 14. The UIM 50 now indicates that direct refueling is off 139 and that onboard refueling is on 117. The fuel gas is now compressed 150 by compressor 14 and cooled by the intercooler 16. The chart continues with item C to the compressed gas exiting the gas cooler 16 and moving 151 to the storage tank 23.

Decision block 152 checks to see if the tank is full, if not the process returns to gas compression 150, if so the process continues to block 153. Decision block 153 is used if there are multiple tanks 23. Block 153 checks if the final tank is filled. If not, then the tank manifold switches over to the next tank 154 and returns to gas compression 150. If so, then the process continues to block 155.

Once the tank(s) is filled, the ECM 21 sends 155 a shut down signal to the motor controller 87 to shut down the compressor 14. The compressor 14 shuts down 156 and terminates the refueling operation. Valves 7, 11, 19, and 86 close 157, and valve 64 opens 158. The three port diverter 66 switches 159 from pathway 17 to pathway 68. The UMI now indicates direct fueling mode on 115 and also displays onboard fueling mode off 133. The hose and power cable are disconnected, and the vehicle is ready for operation.

FIGS. 7A and 7B depicts another example of the centralized control architecture including ECM and UIM and their respective internal components, and the inventories of sensory devices and control devices, respectively, according to embodiments of the invention. FIG. 7A is a detailed schematic illustration of the centralized control architecture highlighting the communication loop between the ECM and UIM and their respective internal components. The ECM 21 is the decision-making core of the system with communication loops 51, 80, 89 linking the UIM 50, motor controller 87, compressor motor 12, various sensory devices 162 and various control devices 161 to the ECM 21. The ECM includes input/output (I/O) ports 180, internal memory 181, and processor 182. Interconnect lines or buses 205 connect the processor 182 and memory 181.

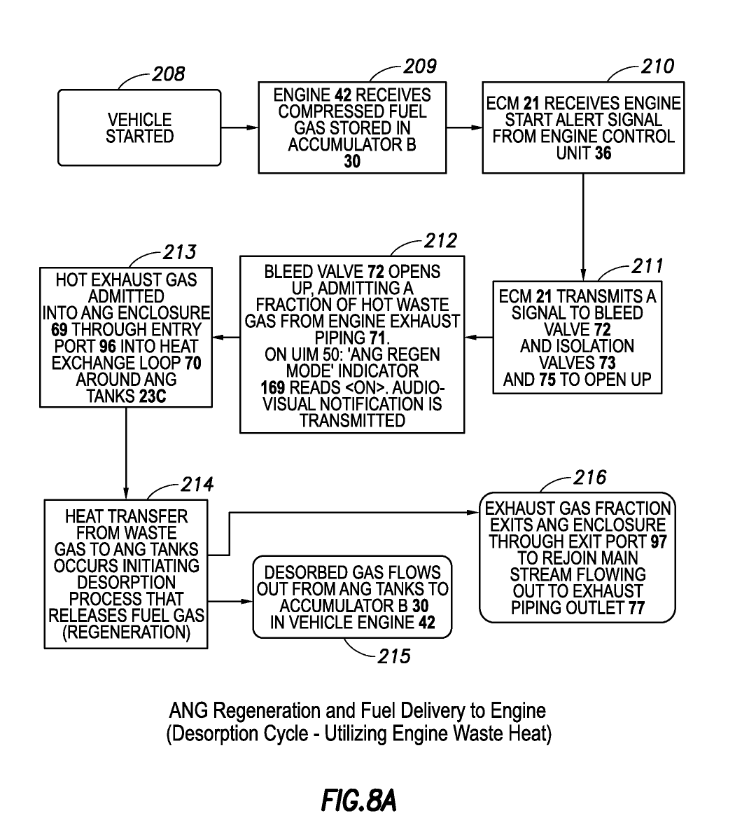

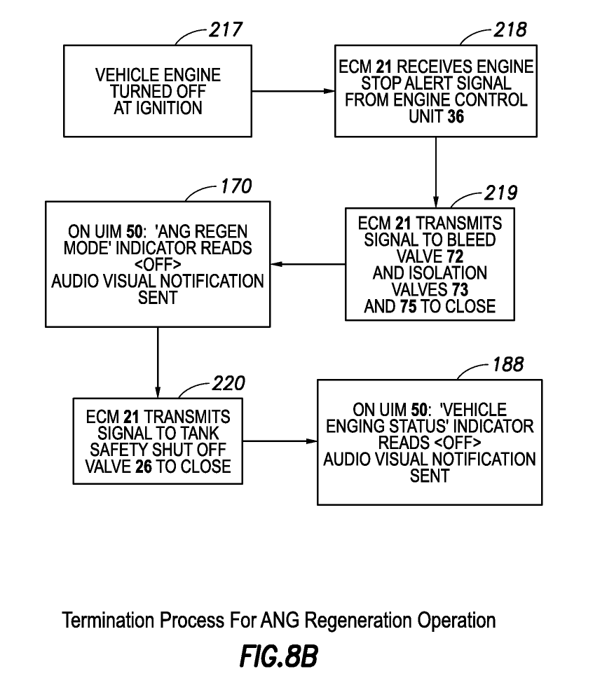

The memory 181 is partitioned into memory blocks 116, 168, 183, and 184. Note that the partitioning is by way of example only, the actual memory may be one block. Memory block 116 contains the onboard refueling instructions. For example, the process of FIG. 6 and chart of FIG. 4A would be stored in block 116. Memory block 168 stores the ANG regeneration (waste heat recovery) instructions. For example, the process of FIG. 8A would be stored in block 168. Memory block 183 is a data storage event history that records the performance data from various sensors 162 along with the states of the various valves 161. Compressor runtime hours and other data would be stored in block 183. Memory block 184 is the ECM shut down program instruction set. For example, the process of FIGS. 5B1 and 5B-2 and the process of FIG. 8B would be stored in block 184.

The frontend 175 of the UIM 50 includes indicators for the various states of the various sensors and control devices as desired, the indication may be visual or audio, or both. The visual indication may be signal light, or dials, or bar graphs as desired. The audio indication may be a chime or voice. Output 140 is an indication of tank pressure from sensor 48 and indicates a fuel gauge (Full to Empty). Output 141 is an indication of tank temperature from sensor 48. Outputs 115, 117, 133, and 139 indicate direct fueling mode on, onboard fueling mode off, onboard fueling mode on, and direct fueling mode off, respectively, from the position of the three port actuator 67 for the valve 66. Outputs 169 and 170 indicate ANG regeneration on and off, respectively, from the position of bleed value 72. Output 186 is an indication of the pressure of the compressor discharge gas from sensor 45. Output 189 is an indication of the temperature of the compressor discharge gas from sensor 46. Outputs 188 and 197 indicate the engine status (on/off) and shutdown indication (for vehicle ignition), respectively, from the vehicle control unit 36. Output 190 is a shutdown indicator (gas leak) from sensor 52. Output 191 is a shutdown indicator (gas leak) from sensor 53. Output 192 is a shutdown indicator (gas impurity) from oxygen/impurity sensor 55. Output 193 is a shutdown indicator (filter) from differential pressure sensor 84. Output 194 is a shutdown indicator (moisture extractor) from differential pressure sensor 85. Output 195 is a shutdown indicator (motion) from accelerometer or motion sensor 78. Output 196 is a shutdown indicator (compressor overheat) from motor temperature sensor 82. Output 187 is a shutdown indicator (pressure relief) from value 18. Output 198 is a shutdown indicator (low pressure in accumulator) from sensor 63. Output 199 is an indication of the compressor motor RPM from sensor 81. Output 200 is an indication of the compressor run hours from chronometer 88. Output 201 is an indication of the compressor motor wattage from meter 83.

Block 204 of the UIM 50 is the control switch hub, and includes network and support interface 163, onboard fueling start control 135, onboard fueling stop control 137, start control for ANG regeneration 171, stop control for ANG regeneration 173 and set-point adjustor 202. Through the set-point adjustor feature, limited adjustments can be made by the manufacturers or vendors to various process settings such as set points for maximum tank fill pressure verse ambient temperature, shutdown threshold for oxygen concentration in fuel gas, shutdown threshold for hydrocarbon concentration in air, etc. This contributes to the tunability aspect of S.T.O.R.M.

The interface 163 sends and receives data from the backend 176 of the UIM via the network controller circuit 177, which is connected to the wireless controller circuit 178. The wireless control circuit sends and receives data from the remote control 114 and/or a central station (not shown), e.g. a dispatch center. Audio output is sent through audio signal processing circuit 185 for voice or sound for on board fuel start 136, voice or sound for on board fuel stop 138, voice or sound for AGN start 172, voice or sound for ANG stop 174. Features 172 and 174 are particularly useful for vendors or manufacturers during troubleshooting and maintenance sessions. The UIM 50 uses interconnect line 206 to connect to various components and includes backend I/O port 179 to communicate with ECM 21.

FIG. 7B depicts the inventory of control devices 161 and the inventory of sensory devices 162. The communication loops may be single, bidirectional wire, or may be two wires. The communication loops may also include power. Note that additional sensors may be used. For example, a carbon monoxide detector could be used to determine if CO gas is leaking into the passenger compartment.

FIGS. 8A and 8B are block diagram flowcharts illustrating examples of an operations for starting and stopping regeneration, according to embodiments of the invention. FIG. 8A is a block diagram flowchart illustrating an example of an operation utilized by the electronic control module to control and operate regeneration operation utilizing engine waste heat for ANG or AFG storage tank, according to embodiments of the invention.

FIG. 8A begins with block 208, where the vehicle is started. In block 209, the engine 42 uses gas fuel stored in accumulator 30 for operations. The ECM 21 receives the engine start signal from the vehicle control unit 36 in block 210. In block 211, the ECM directs the bleeder valve 72 and isolation valve 75 to open. In block 212, the bleeder valve opens and allows a portion of the hot exhaust gas from the engine exhaust into piping 71. The UIM indicates ANG regeneration on either visually or audio, or both. In block 213, the hot gas enters the ANG enclosure 69 through port 96 and into heat exchanger loop 70 around the ANG tank(s) 23c. In block 214, the heat transfers from the exhaust gas to the ANG tank and causes desorption to occur, where the gas is liberated from the ANG material, regeneration. The desorbed gas is delivered to the engine 42 in block 215. Cooled exhaust gas exits the enclosure 69 are rejoins the exhaust gas stream in block 216.

FIG. 8B is a block diagram flowchart illustrating an example of an operation utilized by the electronic control module to terminate gas regeneration operation. In block 217, the engine 42 is turned off. In block 218, the ECM 21 receives the engine stop signal from the vehicle control unit 36. The ECM closes the bleed valve 72, and the isolation valves 73 and 75, in block 219. In block 220, the UIM indicates that ANG regeneration is off by visual and/or audio signal. The ECM shuts off the valve 26 in block 220. The UIM indicates that the engine status is off in block 188.

FIGS. 9A to 9E are a series of illustrations depicting examples of different arrangements for the system of FIG. 1 in different types of vehicles.

In FIG. 9A the vehicle is a car or sport utility vehicle (SUV), and the tanks are located underneath the vehicle and the compressor is located in the rear or trunk. In FIG. 9B, the vehicle is a tractor and the tanks are located in the engine compartment and the compressor is near the driver seat. In FIG. 9C, the vehicle is a bus, and the tanks are located on the roof and the compressor is located at the rear. In FIG. 9D, the vehicle is a car or SUV, and the tanks are located in the rear and the compress located in front of the tanks. In FIG. 9E, the vehicle is a motor cycle, the tanks are located between the wheels and under the driver, while the compressor is located in front of the rear wheel. Note that these arrangement are by way of example only as other vehicles could be used and the tanks and/or compressor could be located in different areas.

Note that any of the functions described herein may be implemented in hardware, software, and/or firmware, and/or any combination thereof. When implemented in software, the elements of the present invention are essentially the code segments to perform the necessary tasks. The program or code segments can be stored in a processor readable medium. The “processor readable medium” may include any physical medium that can store or transfer information. Examples of the processor readable medium include an electronic circuit, a semiconductor memory device, a ROM, a flash memory, an erasable ROM (EROM), a floppy diskette, a compact disk CD-ROM, an optical disk, a hard disk, a fiber optic medium, etc. The code segments may be downloaded via computer networks such as the Internet, Intranet, etc.

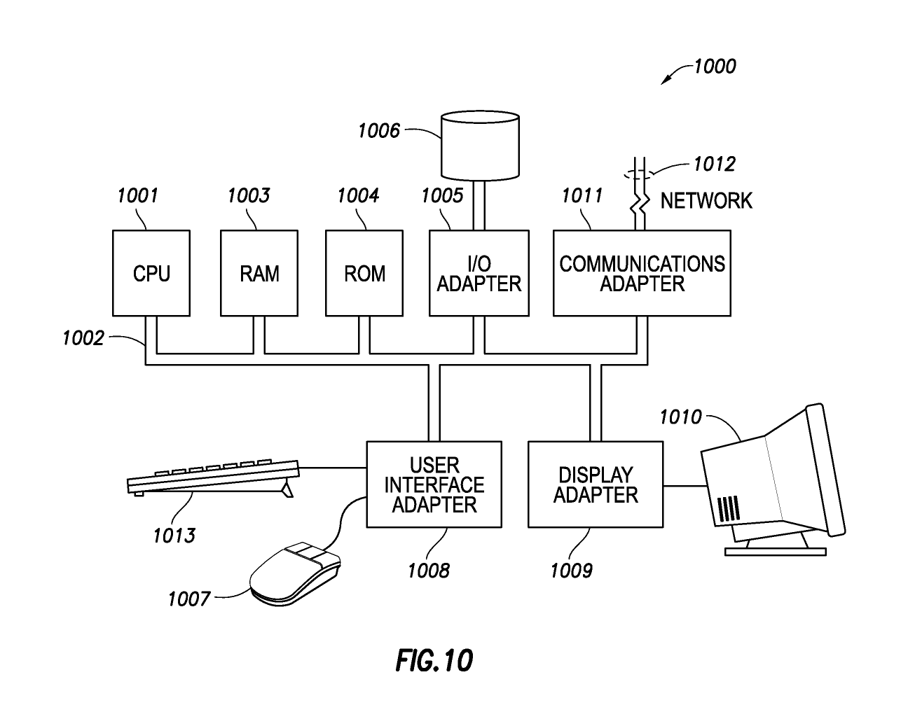

FIG. 10 illustrates computer system 1000 adapted to use the present invention. Central processing unit (CPU) 1001 is coupled to system bus 1002. The CPU 1001 may be any general purpose CPU, such as an Intel Pentium processor. However, the present invention is not restricted by the architecture of CPU 1001 as long as CPU 1001 supports the inventive operations as described herein. The CPU corresponds with the processor 182 of ECM 21. Bus 1002 is coupled to random access memory (RAM) 1003, which may be SRAM, DRAM, or SDRAM. ROM 1004 is also coupled to bus 1002, which may be PROM, EPROM, or EEPROM. RAM 1003 and ROM 1004 hold user and system data and programs as is well known in the art.

Bus 1002 is also coupled to input/output (I/O) controller card 1005, communications adapter card 1011, user interface card 1008, and display card 1009. The I/O adapter card 1005 connects to storage devices 1006, such as one or more of a hard drive, a CD drive, a floppy disk drive, a tape drive, to the computer system. The I/O adapter 1005 is also connected to printer (not shown), which would allow the system to print paper copies of information such as document, photographs, articles, etc. Note that the printer may a printer (e.g. inkjet, laser, etc.), a fax machine, or a copier machine. Communications card 1011 is adapted to couple the computer system 1000 to a network 1012, which may be one or more of a telephone network, a local (LAN) and/or a wide-area (WAN) network, an Ethernet network, and/or the Internet network. User interface card 1008 couples user input devices of the UIM 50, such as keypad (not shown), keyboard 1013, pointing device 1007, and microphone (not shown), to the computer system 1000. User interface card 1008 also provides sound output to a user via speaker(s) (not shown). The speakers may be part of the vehicle's sound system or may be separate speakers. The display card 1009 is driven by CPU 1001 to control the display on display device 1010 of UIM 50. The display device 1010 may a touch screen.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

What is claimed is:

1. A compressed gas fuel system for a vehicle, wherein an engine of the burns higher pressure gas fuel, the system comprising:
a compressor, which is mounted on the vehicle, for compressing lower pressure gas fuel into the higher pressure gas fuel;
at least one storage tank, which is mounted on the vehicle, for storing the high pressure gas fuel; and
an electronic control module, which is mounted on the vehicle, that controls the compressor and controls delivery of high pressure gas fuel from the at least one storage tank to the engine.

2. The compressed gas fuel system of claim 1, further comprising:
a plurality of safety shutoff valves, each of which operates to shut off a flow of gas in the compressed gas fuel system, wherein each safety shutoff is controlled by the electronic control module.

3. The compressed gas fuel system of claim 1, further comprising:
a plurality of check valves, each of which operates to prevent back flow of gas in the compressed gas fuel system.

4. The compressed gas fuel system of claim 1, further comprising:
a plurality of pressure relief valves, wherein at least one pressure relief valve is located adjacent to the compressor and at least another one pressure relief valve is located adjacent to the at one fuel storage tank, each of which operates to provide alternate pressure outlet.

5. The compressed gas fuel system of claim 1, further comprising:
a three port diverter valve that provides a by-pass path for high pressure gas fuel from a high pressure source to by-pass the compressor and fill the at least one storage tank, wherein the three port diverter value is controlled by the electronic control module.

6. The compressed gas fuel system of claim 1, further comprising:
a plurality of temperature sensors, each of which monitors at least one of an ambient temperature and a temperature of a portion of the compressed gas fuel system, wherein each temperature sensor provides data to the electronic control module.

7. The compressed gas fuel system of claim 1, further comprising:
a plurality of pressure sensors, each of which monitors a pressure of a portion of the compressed gas fuel system, wherein each pressure sensor provides data to the electronic control module.

8. The compressed gas fuel system of claim 1, further comprising:
a plurality of filters, each of which removes contaminate from the gas fuel.

9. The compressed gas fuel system of claim 8, further comprising:
a plurality of filter sensors, each of which monitors a respective one of the plurality of filters, wherein each filter sensor provides data to the electronic control module.

10. The compressed gas fuel system of claim 1, further comprising:
a first gas accumulator located upstream of the compressor, wherein the first gas accumulator stores low pressure gas to stabilize the compression of the compressor; and
a second gas accumulator located downstream of the at least one storage tank, wherein the second gas accumulator provides higher pressure gas during startup of the engine.

11. The compressed gas fuel system of claim 1, further comprising:
a plurality of gas detector sensors, each of which detects gas leaks in a portion of the compressed gas fuel system, wherein each gas detector sensor provides data to the electronic control module.

12. The compressed gas fuel system of claim 1, further comprising:
an accelerometer sensor that detects movement of the compressed gas fuel system, wherein the accelerometer sensor provides data to the electronic control module.

13. The compressed gas fuel system of claim 1, wherein the compressor is a multiple stage compressor.

14. The compressed gas fuel system of claim 13, further comprising:
an intercooler that removes heat from compression of the gas fuel after each stage of compression in the compressor.

15. The compressed gas fuel system of claim 13, further comprising:
a revolution per minute sensor that measures the speed of the compressor, wherein the revolution per minute sensor provides data to the electronic control module;
a chronometer sensor that measure a runtime of the compressor, wherein the chronometer sensor provides data to the electronic control module;
a wattage meter that measures a voltage and an amperage of electrical power provided to the compressor, wherein the wattage meter provides data to the electronic control module; and
a flow meter which measures the flow rate of compressed gas discharged from the compressor, wherein the flow meter provides data to the electronic module.

16. The compressed gas fuel system of claim 1, further comprising:
a high strength, lightweight container for the compressor to provide mechanical protection for the compressor, wherein the container provides acoustic reduction for vibrations associated with an operation of the compressor; and
a plurality of vibration dampeners that connect the container to the vehicle and reduce vibrations from the container that are exerted on the vehicle.

17. The compressed gas fuel system of claim 1, further comprising:
an electric power delivery subsystem that provides electrical power to the compressor, wherein the electric power delivery subsystem comprises an electric power intake receptacle located on an exterior of the vehicle.

18. The compressed gas fuel system of claim 1, wherein the electronic control module comprises:
an internal memory unit;
wherein the internal memory unit stores at least one of:
event logs, maintenance data, data captured during operation of the system, set points for the system, onboard refueling operation algorithm, and shutdown algorithm.

19. The compressed gas fuel system of claim 1, wherein the at least one storage tank is one of a cylindrical tank and conformal tank.

20. The compressed gas fuel system of claim 1, wherein the at least one storage tank is an adsorbed fuel gas storage tank.

21. The compressed gas fuel system of claim 20, further comprising:
a heater that is located adjacent to the adsorbed fuel gas storage tank, wherein the heater provides heat to the adsorbed fuel gas storage tank to release the stored gas fuel, wherein the heat is controlled by the electronic control module.

22. The compressed gas fuel system of claim 21, wherein the heater uses at least one of exhaust gas from the engine and electricity to provide heat.

23. The compressed gas fuel system of claim 1, further comprising:
an user interface module that is connected to the electronic control module, wherein the user interface module displays data from the electronic control module and allows a user to input commands to the electronic control module.

24. The compressed gas fuel system of claim 23, where the user interface module is operative to provide one or more of:
process indicators which provide readouts on sensor data, system shutdown/startup indicators, fault indicators, control settings, audio signal processing, set point adjustment controls, wireless interface and control circuits, network interface and control circuits.

25. The compressed gas fuel system of claim 1, wherein the gas fuel is one of natural gas, hydrogen, dimethyl ether (DME), syngas, ethane, propane, a combustible, and combinations thereof.

26. A method of using a compressed gas fuel system for a vehicle comprising:
receiving lower pressure gas fuel from a source external to the vehicle;
compressing the lower pressure gas fuel into higher pressure gas fuel, wherein the compressing is performed onboard the vehicle;
storing the high pressure gas fuel in at least one storage tank;
delivering the high pressure gas fuel from the at least one storage tank to an engine of the vehicle; and
controlling the compressing, storing, and delivering by an electronic control module located onboard the vehicle.

27. The method of claim 26, wherein the receiving comprises:
connecting the vehicle to the source with a breakaway hose, wherein the source is an outlet for utility fuel gas; and
opening a plurality of safety valves, each of which operates to shut off a flow of gas in the system, via the electronic control module.

28. The method of claim 27, wherein the receiving comprises:
switching a three port diverter valve that provides a by-pass path for high pressure gas fuel from a high pressure source to by-pass the compressor and fill the at least one storage tank to provide a path to the compressor, via the electronic control module; and
an closing a safety valve to shut off a flow of gas in the by-pass path, via the electronic control module.

29. The method of claim 26, wherein the compressing is performed by compressor, wherein the compressor is a multiple stage compressor, and the compressing comprises:
providing electrical power to a compressor; and
removing heat from each stage of the compressor by an intercooler.

30. The method of claim 29, wherein the removing heat comprises:
using one of air, liquid, gas, or a phase change material to remove heat.

31. The method of claim 26, wherein the storage tank is one of a cylindrical tank and conformal tank.

32. The method of claim 26, wherein the at least one storage tank is an adsorbed fuel gas storage tank.

33. The method of claim 32, wherein delivering comprises:
heating the adsorbed fuel gas storage tank to release the stored fuel gas, wherein the heating is controlled by the electronic control module.

34. The method of claim 33, wherein the heating comprising:
bleeding exhaust gas from the engine;
passing the bled exhaust gas adjacent to the adsorbed natural gas storage tank to transfer heat from the bled exhaust gas to the adsorbed natural gas storage tank; and
returning the cooled exhaust gas back to an exhaust system.

35. The method of claim 26, further comprising:
shutting down the compressing by the electronic control module.

36. The method of claim 35, wherein shutting down comprises:
closing a plurality of safety valves, each of which operates to shut off a flow of gas in the system, via the electronic control module.

37. The method of claim 35, wherein shutting down comprises:
initiating the shutting down when the electronic control module receives a signal from a sensor that indicates that a threshold has been exceeded.

38. The method of claim 26, further comprising:
displaying a status of the system to a user via a user interface module; and
providing commands to the electronic control module via the user interface module.

39. A compressed gas fuel system for a vehicle, wherein an engine of the burns higher pressure gas fuel, the system comprising:
a compressor that compresses lower pressure gas fuel into the higher pressure gas fuel;
a least one storage tank that stores the high pressure gas fuel;
a first sensor that measures and ambient air temperature;
a second sensor that measures a temperature of the at least one storage tank;
means for controlling the system to optimize an amount of higher pressure gas fuel that is stored in the at least one storage tank using information from the first and second sensor.
